(19) United States
(12) Patent Application Publication
(10) Pub. No.: US 2023/0373877 A1
(43) Pub. Date: Nov. 23, 2023

(54) SYSTEM AND METHOD OF LIQUID FERTILIZER GENERATION

(71) Applicant: SunFertilize Inc., Needham, MA (US)

(72) Inventors: Juan Pablo TRELLES, Sudbury, MA (US); Samuel Marcus ALPERT, Needham, MA (US); Benard TABU, Lowell, MA (US); Visal VENG, Lowell, MA (US)

(21) Appl. No.: 18/199,273

(22) Filed: May 18, 2023

Related U.S. Application Data
(60) Provisional application No. 63/343,545, filed on May 19, 2022.

(51) Int. Cl. C05G 5/20; C05C 5/00; B01J 19/08; A01C 23/02; A01C 23/00

(52) U.S. Cl. CPC C05G 5/20; C05C 5/00; B01J 19/088; A01C 23/023; A01C 23/007; A01C 23/001; B01J 2219/0896; B01J 2219/0807; B01J 2219/0877; B01J 2219/0801

(57) ABSTRACT

A system and method produces nitrogen-based fertilizer, which is synthesized from air and water using renewable electricity, mainly from solar energy and low-temperature plasma technology and stored prior to distributing to plants via drip irrigation. The process of liquid fertilizer generation and system description are presented. A glass reactor with a digital 3D-printed end flange is utilized as a reactor chamber. The system and method synthesize a product that is primarily a liquid nitrate (NO₃⁻) based fertilizer in an aqueous solution.

### BACKGROUND

The use of fertilizer in agriculture has become an essential component of ensuring adequate food supply to support a growing population, especially in developing countries such as sub-Saharan Africa, where inadequate access to affordable fertilizer results in adverse hunger and famine in the region. To meet the increasing demand, synthetic fertilizers, including nitrogen (N), phosphorous (P), and potassium (K), are prevalent in the commercial farming industry. Nitrogen fertilizer is the main nutrient for plant growth which accounts for over 50% of global synthetic fertilizers globally. However, when nitrogen fertilizer is applied to plants, only 30-40% of nitrogen is absorbed by the plants, and the rest is wasted or drained into the water, causing water pollution, or “nitrogen runoff.”

In the United States and worldwide, most nitrogen fertilizer is based on ammonia produced using the Haber-Bosch process, an almost century-old process that has been extensively developed, with current implementations depicting efficiencies close to the theoretical maximum. Nevertheless, the Haber-Bosch process presents important limitations. Specifically, the Haber-Bosch process requires high temperatures (300° to 500° C.) and high-pressures (60 to 180 atm), resulting in complex large-scale installations with significant energy consumption, which generally contribute to high amounts of environmental emission byproducts (such as CO₂). There are also high transportation costs associated with fertilizer that vary based on fuel prices. By some estimates, fertilizer production releases approximately 1.4% of global carbon dioxide CO₂ emissions and consumes almost 2.0% of global energy production needs.

Thus, decarbonizing fertilizer manufacturing would improve sustainability and reduce energy use. An environmentally beneficial system would allow for a decentralized and decarbonized approach to fertilizer production.

### SUMMARY OF THE EMBODIMENTS

In a first aspect, an apparatus for generating low-temperature plasma to synthesize fertilizer using ambient air, plasma, and water to create NO₃⁻ (nitrates) as a fertilizer solution (Plasma-Activated Water, or PAW) is disclosed. The system may be used for on-site and on-demand delivery by integrating it into an existing drip irrigation system or other irrigation approaches.

In a second aspect, a method of synthesizing nitrogen-based fertilizer from air and water on-site uses low-temperature atmospheric air plasma powered by electricity mainly from renewable energy sources such as solar and wind.

### BRIEF DESCRIPTION OF THE FIGURES

FIG. 1 is a schematic diagram of a system for generating low-temperature plasma to synthesize fertilizer, in embodiments.

FIG. 2A is a side view of a plasma reactor for use in a system to synthesize fertilizer, in embodiments.

FIG. 2B is a top view of the plasma reactor of FIG. 2A.

FIG. 3 is a cross-sectional side view of another embodiment of a plasma reactor.

FIG. 4 is a side view of another version of a plasma reactor with an alternate position of a ground electrode.

FIG. 5 is a flowchart illustrating a method for fabricating an STI structure in a wafer substrate of an image sensor according to an embodiment.

FIG. 6 is a graph illustrating results achieved by the system of FIG. 1, in embodiments.

### DETAILED DESCRIPTION OF THE EMBODIMENTS

Exemplary embodiments will be described in detail herein, with examples thereof represented in the drawings. When the following descriptions involve the drawings, like numerals in different drawings represent like or similar elements unless otherwise indicated. Implementations described in the following exemplary embodiments do not represent all implementations consistent with the present disclosure. Instead, they are merely examples of apparatuses and methods consistent with some aspects of the present disclosure as detailed in the appended claims.

Plasma is an ionized gas consisting of electrons, ions, neutrals, and molecules. Generally, plasma in technological applications are characterized as being of two types: thermal and nonthermal plasma. In thermal plasma, both electrons and so-called heavy species in the plasma (atoms, ions, molecules) have approximately the same high temperature, usually between 8,000 to 20,000 K. However, nonthermal plasma exhibits higher electron temperature (typically higher than ˜11,000) compared to the background gases and heavy species. Further, non-thermal plasma applications generally have higher energy efficiency and selectivity. As disclosed herein, the use of solar as an energy source to generate the transferred-discharge plasma mode as well as the in-situ production of fertilizer in a distributed manner is a novel approach that may help smaller farms, communities, and countries that do not have access to large fertilizer manufacturing plants utilizing the Haber-Bosch process.

The system and method disclosed herein provides nitrogen fertilizer in a low-cost, decentralized manner while mitigating nitrogen pollution and carbon dioxide (CO₂) emissions commonly associated with fertilizer production. Farmers may adapt their existing drip irrigation systems to use fertilizer from a modular system. The technology tackles three main issues: first, this technology utilizes electricity mainly from renewable energy sources such as solar and wind help mitigate climate change and pollution from the Haber-Bosch fertilizer production process. Second, it minimizes nitrogen runoff where chemical fertilizer is over-utilized, causing water pollution and is harmful to the ecological system. Finally, it is economically viable in a way that lowers expenses and increases food production, contributing significantly to global food security and sustainable development. This system produces fertilizer on-site, eliminating transportation costs. The systems and methods disclosed herein may be utilized in remote off-grid areas, benefiting disadvantaged communities. The system is compact and modular, making it linearly-scalable to meet the growing demand for sustainable carbon-neutral fertilizer.

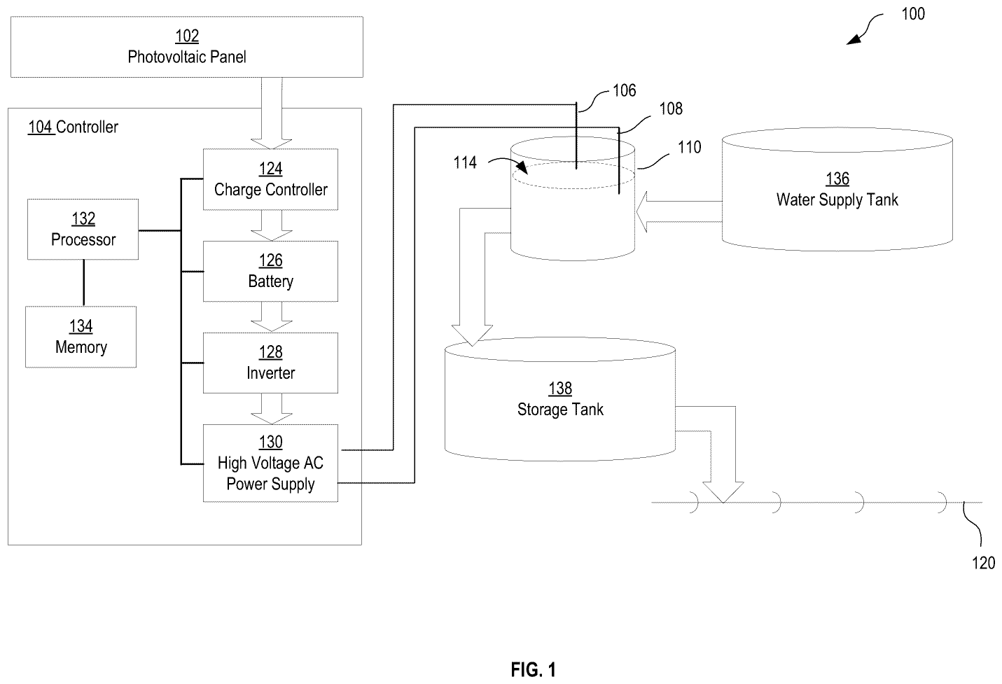

FIG. 1 is a schematic diagram of a system 100 for generating low-temperature plasma to synthesize fertilizer using ambient air, plasma, and water. Photovoltaic (PV) panel 102 converts sunlight into a DC current that is received by controller 104. In embodiments, other sources of electrical energy may also be used, including other renewable sources such as wind and geothermal. Controller 104 uses the DC current to generate high voltage alternative current and control powered electrode 106 and ground electrode 108 to generate plasma inside plasma reactor 110. In embodiments, plasma reactor 110 may have a volume of approximately one gallon, but any volume may be used depending on the quantity of fertilizer needed for a particular application.

Controller 104 includes several components. In the representative embodiment shown in FIG. 1, charge controller 124 regulates the current supplied from PV panel 102 and stores energy in the battery 126. Inverter 128 inverter converts DC power input from battery 126 to AC power output. Inverter may also or alternatively convert DC power directly input from PV panel 102. Power supply 130 scales the power from inverter 128 to a high voltage sufficient to control powered electrode 106 and ground electrode 108 to produce plasma. In embodiments, power supply 130 generates a non-pulsed voltage of at least 20 kV. In a further embodiment, battery 126 and inverter 128 may be omitted, and charge controller 124 and power supply 130 may be integrated into a single integrated circuit. In that case, there is no need to turn the power supply on or off, system 100 will just operate continuously when the sun is shining. Controller 104 also includes processor 132 which executes instructions stored in non-transient memory 134 to operation of system 100 as described herein.

Plasma reactor 110 receives water from water supply tank 136, which is treated with plasma generated by powered electrode 106 and ground electrode 108. After treatment, plasma-activated water (PAW) may be stored in storage tank 138 for a period of time until used or sent directly to drip irrigation line 120. In embodiments, the period of time may be 30 min up to one day or more, depending on irrigation needs. The reactivity produced by the plasma leads to nitrates being formed continuously after plasma treatment up to approximately one day after plasma treatment.

Drip irrigation line 120 is a water distribution system that will supply water and fertilizer to plants. A pump (not shown) may be used to move PAW from plasma reactor 110 or storage tank 138 into drip irrigation line 120, or components of system 100 may be positioned so that drip irrigation lines 120 are gravity fed. Valves (not shown) may be installed between at various locations to manage the flow of water in system 100. They may be manually opened and closed, or they may be controlled by controller 104. Water pumps may be used to maintain a certain pressure level suitable for the water delivery lines in drip irrigation systems. Further, sensors may be installed at various locations to collect data about the operation of system 100 including water levels and flow, nitrate concentration of PAW, or soil moisture, for example, which may be used by controller 104 to manage the operation of system 100.

Lid 112 is provided with holes to allow ambient air to enter plasma reactor 110, as will be discussed in more detail below. As shown, powered electrode 106 is secured in lid 112 while ground electrode 108 enters plasma reactor 110 at the bottom. Other arrangements of ground electrode 108 are possible as long as the tip of ground electrode 108 is submerged below surface 114 of the water inside plasma reactor 110. powered electrode 106 is secured in lid 112 so that a tip of powered electrode 106 is maintained at a distance of approximately 10 mm above surface 114 of the water. In embodiments, the distance between the tip of powered electrode 106 and surface 114 may be from approximately 5 to 15 mm.

Water is provided to plasma reactor 110 from a water supply tank (not shown) through inlet 116. A valve may be provided to control how much water is allowed to enter plasma reactor 110 so as to maintain the correct distance between powered electrode 106 and surface 114. The valve (not shown) may be manually controlled or automated. Outlet 118 from plasma reactor 110 may be connected to a storage tank (not shown) for storing plasma-activated water (PAW). The storage tank may be connected to drip irrigation lines 120 for providing plasma-activated water to plants. In embodiments, outlet 118 may be connected directly to drip irrigation lines 120. In further embodiments, manual or programmatically controlled valves may be used between any of outlet 118, drip irrigation lines 120, and a storage tank. The system of FIG. 1 may also include one or more sensors to provide information about the operation of the system to controller 104.

In embodiments, all or some of the components of system 100 except drip irrigation lines 120 may be located in a compact enclosure that is portable and easily moved. Specifically, charge controller 124 and power supply 130 may be integrated in a single integrated circuit of a few square centimeters in size. In embodiments, an electric battery may not be needed if the system is designed to operate only when the sun is shining, hence producing fertilizer only when plants need it. In embodiments, selected components of system 100 may be positioned either indoor or outdoor as needed for a particular application.

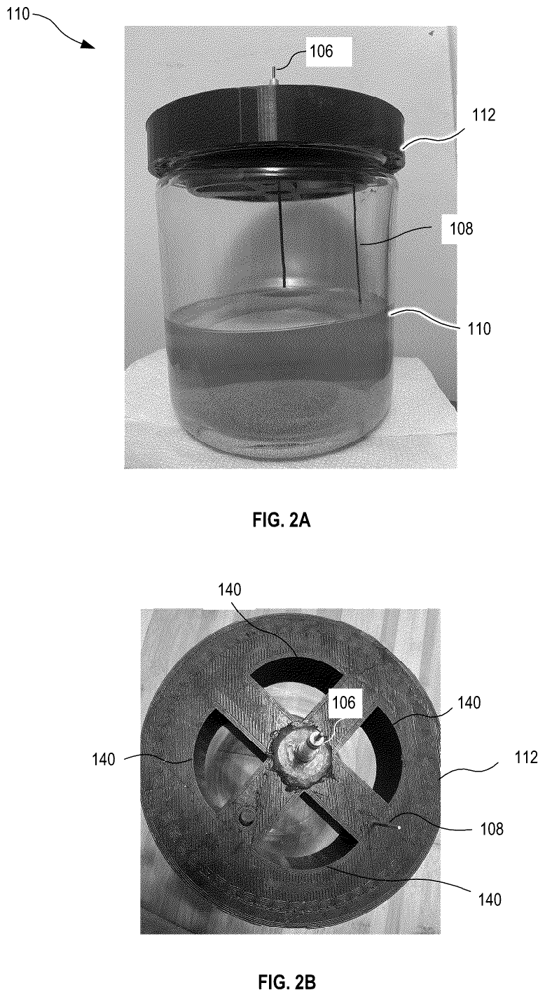

FIG. 2A is a side view of plasma reactor 110. FIG. 2B is a top view of plasma reactor 110. In embodiments, plasma reactor 110 is a glass container with a lid 112 designed to allow air circulation. As shown, plasma reactor 110 is cylindrical but other shapes are contemplated. Lid 112 may be made of a plastic material. In embodiments, lid 112 may be formed using additive manufacturing or other low-cost manufacturing strategy such as plastic extrusion. Powered electrode 106 is inserted through a ceramic insulator and stainless-steel fitting in the center of lid 112 to provide stability. The fitting may be designed to be capable of adjusting the height of electrode 106. Ground electrode 108 is positioned some distance away from powered electrode 106. The exact position of ground electrode 108 is not as important as the fact that the end of the electrode is submerged in the water inside plasma reactor 110. Openings 140 in lid 112 allow ambient air to circulate through plasma reactor 110.

In embodiments, plasma reactor 110 may include two or more powered electrodes 106. When using a plurality of powered electrodes, they are positioned at a minimum distance from each other to prevent interaction between powered electrodes instead of between each powered electrode and surface 114 of the water inside plasma reactor 110.

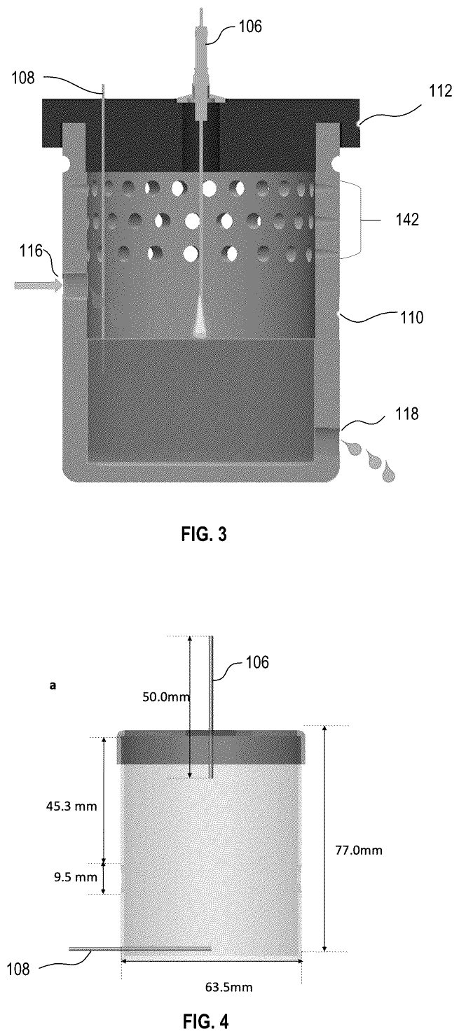

FIG. 3 is a cross-sectional side view of another embodiment of plasma reactor 110. Instead of or in addition to openings 140 in lid 112, openings 142 are provided around the circumference of plasma reactor 110. Although a size and quantity of openings 142 are shown, this is for purposes of illustration, and any number of openings may be provided as long as sufficient ambient air is provided inside plasma reactor 110 to support the syncretization of nitrates.

FIG. 4 is a side view of another version of plasma reactor 110 with an alternate position of ground electrode 108. The location of the ground electrode may affect the transport of electric current through water and therefore the net production of nitrates in water.

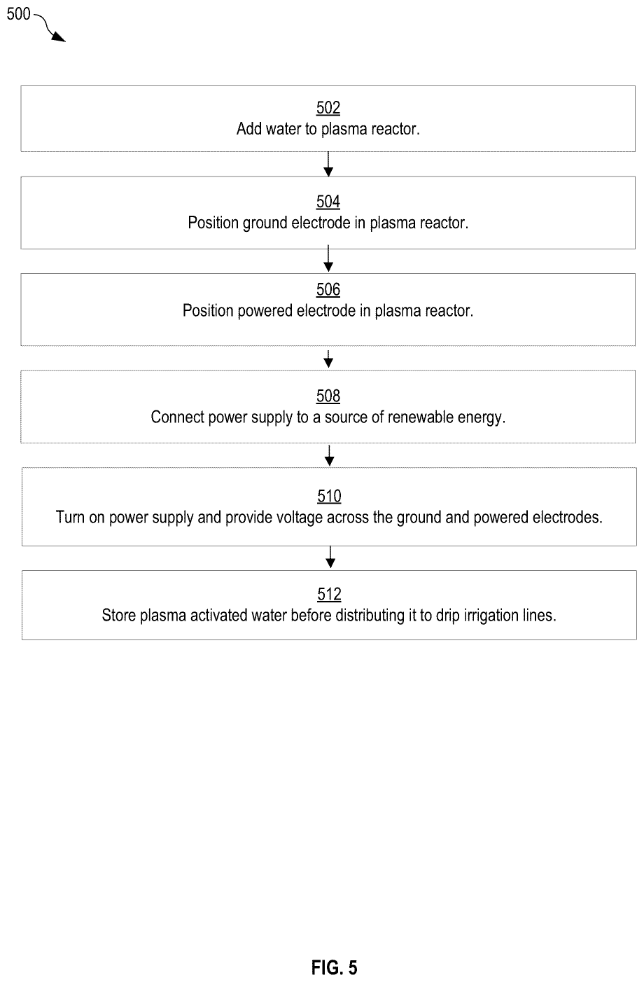

FIG. 5 is a flowchart of a method 500 for producing liquid nitrogen fertilizer. Method 500 includes steps 504, 506, 510, and 512. In embodiments, method 500 also includes at least one of steps 502 and 508.

In step 502, water is added to plasma reactor 110. In an example of step 502, water may be pumped from a storage tank or other water source. A submersible pump may be used. Other methods of adding water to plasma reactor 110 may also be used.

In step 504, ground electrode 108 positioned in plasma reactor 110. In an example of step 504, ground electrode 108 is inserted through lid 112 of plasma reactor 110 and positioned so that the tip of ground electrode 108 is positioned below a surface 114 of the water in the plasma reactor.

In step 506, powered electrode 106 is positioned in plasma reactor 110. In an example of step 504, powered electrode 108 is inserted through a stainless steel or similar fitting in lid 112 of plasma reactor 110 and positioned so that the tip of powered electrode 106 is located approximately 10 mm above surface 114 of the water. In embodiments, the tip of powered electrode 106 may be positioned between approximately 5 and 15 mm. In further embodiments, step 506 may be performed before or after step 504.

In step 508, power supply 130 is connected to a renewable energy source. In an example of step 508, controller 104 is connected to PV panel 102 or another renewable energy source and stores electrical charge in battery 126 for use by power supply 130.

In step 510, power supply 130 is turned on at an appropriate voltage level setting for a first period of time to generate PAW. In an example of step 510, power supply 130 may provide voltage that varies from 0 to 40 kV for a first period of time. In an embodiment, the voltage may be between 1 and 5 kV. In embodiments, the first period of time may be approximately six to eight hours, depending on the season. Power supply 130 may be turned off after the first period of time. In embodiments, power supply 130 may operate continuously when the sun is shining, thus producing fertilizer when plants need it. When connected to electrodes 106 and 108, an electric discharge is generated from the tip of powered electrode 106 impinging on the water. This electric discharge consists of partially ionized air (mainly nitrogen and oxygen) when it reacts with water to produce nitrates (NO₃⁻) and some auxiliary ions such as nitrites and ammonium. In this configuration, the water is electrically coupled, and the electrical design of the system can provide direct control over the amount of electric current and power delivered to the water. In embodiments, the first period of time may be selected to produce approximately 100-200 milligrams of nitrates per liter of water in plasma reactor 110 when power supply 130 is providing 20 kV of voltage between powered electrode 106 and ground electrode 108.

In step 512, PAW is stored for a second period of time before being distributed to drip irrigation lines. In an example of step 512, PAW may be stored in plasma reactor 110 or a separate storage tank 138 for a second period of time between approximately 30 minutes and 48 hours. PAW may be moved using a pump or through gravity. The flow rate of PAW into drip irrigation lines 120 may be adjusted manually or automatically by controller 104 using one or more valves. The PAW produced in the first period of time of using plasma reactor 110 may be stored for up to two days in a closed container such as storage tank 138. The water-rich nitrate is then stored for an optimum period to enhance nitrate production. For example, the fertilizer may be kept in an air-tight container with a lid for one week before being distributed to drip irrigation line 120. In embodiments, PAW may be mixed with non-PAW before distribution to drip irrigation line 120.

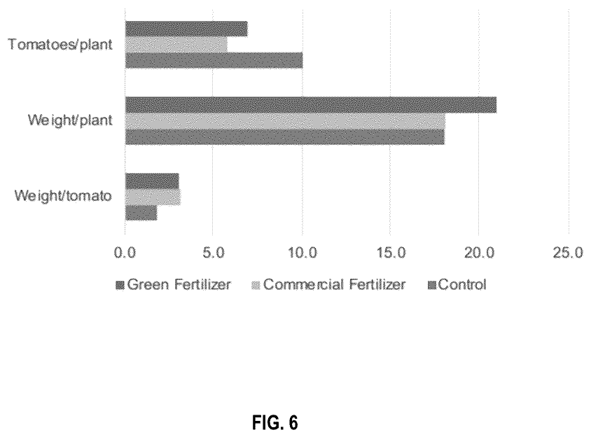

FIG. 6 is a graph illustrating results achieved by system 100 when used in an urban garden setting with tomato plants. Plant growth using PAW from system 100 as a test fertilizer was comparable to the growth of plants when a commercially available fertilizer was applied to a control group. Vegetable production for PAW fertilizer from system 100 was higher than in the comparison and control groups. Nitrates (NO₃⁻) content was compared and had positive results. Soil nitrates did not increase after test fertilizer application. Overall, these results were positive and indicated the possibility to both increase the concentration of PAW fertilizer applied as well as to scale up the number of plants being tested.

FIG. 6 illustrates weight measurements in ounces over the lifecycle of the tomato plants. Tomatoes were harvested the tomatoes from three comparison groups: PAW test fertilizer, a commercial fish fertilizer, and a control group that received only tap water without fertilizer. The measurements of weights were performed over a period of about 4 weeks of harvests and resulted in positive results where the test fertilizer solution provided more weight per tomato plant on a normalized basis.

The nitrates (NO₃⁻) content of commercially bought tomatoes, both medium tomatoes and cherry tomatoes were compared to tomatoes grown with tap water (control), commercial fish fertilizer and sustainable PAW fertilizer. As shown in Table 1 below, the nitrates content of tomatoes grown with sustainably manufactured fertilizer is comparable to or lower than the nitrates found in the other tomatoes tested.

TABLE 1

| | Nitrates Measured | Compared to Control Group |
|---|---|---|
| Tap Water (Control) | 57 | N/A |
| Fish Fertilizer | 67 | 118% |
| PAW Fertilizer | 63 | 112% |

Soil samples were tested prior to fertilizer application and mid-season, and the samples showed a decrease in nutrients after the growing season had begun. This could imply that there are some nitrates leaching from both the fertilized soils as well as the tap water cases. However, the amount of nitrates from the control case being more than the green fertilizer scenario could mean that the nitrates in tap water are less able to be absorbed directly by the plant after the season has begun than the tomatoes that were fed with test green fertilizer.

TABLE 2

| | Nitrates | Nitrates | | |
|---|---|---|---|---|
| | Measured | Measured | pH | pH |
| | Pre-season | Mid-season | Pre-season | Mid-season |
| Tap Water (Control) | 23 | 75 | 7.1 | 5.9 |
| Fish Fertilizer | 23 | 54 | 7.1 | 6.0 |
| PAW Fertilizer | 23 | 32 | 7.1 | 6.2 |

System 100 as disclosed herein solves the increasing need for fertilizer at a low cost while mitigating nitrogen pollution and carbon-dioxide emissions mainly associated with the traditional fertilizer manufacturing process. The system synthesizes nitrogen-based fertilizer from air and water on-site using low-temperature atmospheric air plasma powered by renewable energy sources such as solar panels and wind turbines. The transferred discharge plasma generated by the pin-to-water plasma reactor configuration operates at ambient conditions, making it suitable for compact, low-cost, and resilient embodiments suitable for fertilizer production on-site, where the plants need it. The generated plasma consisting mainly of ionized nitrogen and oxygen undergoes multiple reactions with water to produce nitrate and other auxiliary ionic species such as nitrite and ammonium. The system is integrated with the fertilizer storage tank, which enhances the production of more nitrate after the post-plasma reaction. Additionally, the system is modular and equipped with an on-demand delivery system easily adaptable to existing drip-irrigation systems, proving its adaptability, resiliency, and environmental benignity, leading to the decarbonization of fertilizer manufacturing. The technology's reliance on renewable energy sources such as solar and wind is environmentally friendly and sustainable.

Changes may be made in the above methods and systems without departing from the scope hereof. It should thus be noted that the matter contained in the above description or shown in the accompanying drawings should be interpreted as illustrative and not in a limiting sense. Herein, and unless otherwise indicated: (a) the adjective “exemplary” means serving as an example, instance, or illustration, and (b) the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

What is claimed is:

1. A method for producing liquid nitrogen fertilizer comprising:
supplying water to a plasma reactor;
positioning a ground electrode in the water inside the plasma reactor;
positioning a powered electrode approximately 5 to 15 mm above a surface of the water in the plasma reactor;
connecting a power supply to a renewable energy source;
providing a non-pulsed voltage of approximately 0 to 40 kV across the ground electrode and powered electrode from the power supply for a first period of time to synthesize plasma activated water (PAW); and
after the first period of time, storing the PAW for a second period of time before distributing the PAW to drip irrigation lines.

2. The method of claim 1, wherein the first period of time is at least six hours.

3. The method of claim 2, further comprising selecting the first period of time to produce approximately 100-200 milligrams of nitrates per liter of water.

4. The method of claim 1, wherein the second period of time is approximately 30 minutes to 48 hours.

5. The method of claim 1, wherein the PAW is mixed with non-PAW before distribution to the drip irrigation lines.

6. The method of claim 1, wherein the renewable energy source is one or more photovoltaic panels, the method further comprising:
collecting solar energy using the one or more photovoltaic panels; and
storing the solar energy in a battery.

7. The method of claim 6, further comprising:
converting DC power from the battery to AC; and
using the AC power to provide the non-pulsed voltage across the ground and powered electrodes.

8. The method of claim 1, further comprising:
pumping the plasma activated water to a storage tank; and
leaving the plasma activated water in the storage tank for the second period of time before sending it to drip irrigation lines to increase a quantity of nitrate in the water.

9. The method of claim 1, wherein the renewable energy source is a wind turbine, the method further comprising:
collecting renewable energy using at least one of a photovoltaic panel or a wind turbine; and
storing the collected energy in a battery.

10. A system for producing liquid nitrogen fertilizer comprising:
a renewable energy source for providing electrical current;
a controller for receiving the electrical current and converting it into a high voltage alternating current (AC);
a plasma reactor for receiving and retaining water that will be synthesized into plasma-activated water (PAW);
a powered electrode coupled to the controller for receiving the high voltage AC;
a ground electrode coupled to ground; and
a drip irrigation line coupled to an outlet of the plasma reactor for receiving PAW and providing it to plants under the control of the controller.

11. The system of claim 10, the controller further comprising:
a processor for controlling an operation of the system automatically;
a memory for storing data;
a charge controller for receiving electricity from the renewable energy source; and
a power supply for providing the high voltage AC.

12. The system of claim 11, the controller further comprising:
a battery for storing electricity received from the charge controller; and
a inverter for converting DC voltage from the battery to AC voltage.

13. The system of claim 10, further comprising:
a storage tank; and
a pump to move water from the plasma reactor to the storage tank and from the storage tank to drip irrigation lines.

14. The system of claim 13, drip irrigation lines are gravity fed.

15. The system of claim 13, further comprising a valve between the storage tank and the drip irrigation lines.

16. The system of claim 15, wherein the valve is opened and closed by the controller bases on sensing a water level in the tank.

17. The system of claim 10, further comprising a compact enclosure that is portable and easily moved to allow for both indoor and outdoor fertilizer production.

18. The system of claim 10, further comprising a second powered electrode.

19. The system of claim 10, wherein the renewable energy source is a photovoltaic (PV) panel for converting sunlight into electrical current.

20. The system of claim 10, wherein the renewable energy source is a wind turbine.
